(19) United States
(12) Patent Application Publication
(10) Pub. No.: US 2025/0350627 A1
(43) Pub. Date: Nov. 13, 2025

(54) NETWORK SECURITY OPERATION WORKBENCH

(71) Applicant: Huaneng Information Technology Co., Ltd., Qingdao (CN)

(72) Inventors: Shuo Han, Qingdao (CN); Sheng Ye, Qingdao (CN); Hao Guo, Qingdao (CN); Wenwei Liu, Qingdao (CN); Cheng Fan, Qingdaoo (CN); Yubao Zhou, Qingdao (CN); Shouhui Xin, Qingdao (CN); Huanxiu Ding, Qingdao (CN); Wei Li, Qingdao (CN)

(73) Assignee: Huaneng Information Technology Co., Ltd., Qingdao, SD (CN)

(21) Appl. No.: 19/260,435

(22) Filed: Jul. 4, 2025

(30) Foreign Application Priority Data
Jun. 6, 2025 (CN) 202510756931.2

(51) Int. Cl. H04L 9/40

(52) U.S. Cl. CPC H04L 63/1441; H04L 63/1425; H04L 63/1433

(57) ABSTRACT

A network security operation workbench is provided, and relates to the technical field of network security, and includes: a data monitoring module, configured for performing security monitoring on network events in systems, identifying abnormal data and outputting to obtain abnormal information; a threat analysis module, configured for performing secondary identification on the abnormal information by using preset identification algorithms, obtaining threat types and levels corresponding to abnormal events in the abnormal information, and generating threat identification information; a risk processing module, configured for analyzing the threat identification information, matching to obtain corresponding coping strategies and methods, and performing security management operations on the abnormal events based on the coping strategies and methods; a log generation module, configured for recording an identification and analysis process and a security management operation process of each of abnormal events in the systems and generating a threat management log.

### CROSS-REFERENCE TO RELATED APPLICATIONS

This application claims priority of Chinese Patent Application No. 202510756931.2, filed on Jun. 6, 2025, the content of which is hereby incorporated by reference.

### TECHNICAL FIELD

The disclosure relates to the technical field of network security, and in particular to a network security operation workbench.

### BACKGROUND

With the rise of technologies such as big data, cloud computing, Internet of Things and mobile Internet, the physical boundaries of data are becoming more and more blurred, virtualization technologies and devices in the system are widely used, and the types and quantities of various asset objects in the network are increasing day by day, which makes it more difficult to process network security information, and the risks of network security are constantly being amplified by technology. Therefore, how to effectively identify and dispose of threat information in network information has become an urgent problem.

At present, traditional threat identification methods rely heavily on manually defined rules. Although the identification accuracy of threat information that has occurred is high, with the increasing number of threat events by new technical means, traditional threat identification methods have gradually become more willing than able, and unable to cope with complex and changeable threat attack methods and events.

Therefore, a network security operation workbench is provided.

### SUMMARY

A network security operation workbench is provided, and is used for improving the recognition accuracy of abnormal information in network information, further accurately identifying hidden threat events, and timely processing the threat events, thereby continuously improving the security and flexibility of the network platform.

A network security operation workbench is provided and includes:
a data monitoring module, configured for performing security monitoring on network events in systems, identifying abnormal data and outputting to obtain abnormal information;
a threat analysis module, configured for performing secondary identification on the abnormal information by using preset identification algorithms, obtaining threat types and levels corresponding to abnormal events in the abnormal information, and generating threat identification information;
a risk processing module, configured for analyzing the threat identification information, matching to obtain corresponding coping strategies and methods, and performing security management operations on the abnormal events based on the coping strategies and methods;
a log generation module, configured for recording an identification and analysis process and a security management operation process of each of abnormal events in the systems and generating a threat management log.

Preferably, the data monitoring module includes:
a data obtaining submodule, configured for obtaining log data of all the network events in the systems and preprocessing the log data to obtain initial data; and
a data identification submodule, configured for identifying and analyzing abnormal data in the initial data and outputting to obtain the abnormal information.

Preferably, the threat analysis module includes:
a first feature extraction submodule, configured for performing feature extraction on the abnormal information to obtain abnormal data features; and
an algorithm matching submodule, configured for selecting and obtaining corresponding preset identification algorithms in an algorithm database based on the abnormal data features.

Preferably, the threat analysis module further includes:
a secondary identification submodule, configured for performing secondary identification on abnormal information by using the preset identification algorithms to obtain threat type information and corresponding level information of each of the abnormal events;
an information generation module, configured for counting the threat type information and corresponding level information of all the abnormal events to generate threat identification information.

Preferably, the risk processing module includes:
a second feature extraction submodule, configured for performing feature extraction on features from the threat identification information to obtain threat data features;
a strategy-method matching submodule, configured for matching in a preset strategy and method database based on the threat data features to obtain corresponding threat processing strategies and threat processing methods;
a security management submodule, configured for performing security
management operations on corresponding abnormal events in the systems based on the threat processing strategies and the threat processing methods.

Preferably, the strategy-method matching submodule includes:
a factor obtaining unit, configured for converting the threat data features into a threat matching factor with a preset format;
an information matching unit, configured for selecting historical threat information with a matching degree greater than a first preset degree in a historical threat database based on the threat matching factor, and outputting to obtain first threat information;
simultaneously selecting historical threat information with a matching degree less than the first preset degree but greater than a second preset degree from the historical threat database, and outputting to obtain second threat information;
where when a matching degree in the historical threat database based on the threat matching factor is less than the second preset degree, converting corresponding threat data features into an online identification format, and transmitting to a cloud database for identification and analysis, and outputting to obtain third threat information based on identification results and manual determining results;
a historical strategy-method matching unit, configured for obtaining corresponding historical threat processing strategies and historical threat processing methods in a historical threat coping strategy-method database based on the first threat information and the second threat information;
a strategy design unit, configured for isolating threat events and related systems by combining level information corresponding to threat when input threat information is the third threat information, performing threat coping strategy design through system self-matching instructions and manual operation instructions, and outputting self-defined strategies and methods; and
a threat preprocessing unit, configured for preprocessing corresponding threat events based on the historical threat processing strategies, the historical threat processing methods and the self-defined strategies and methods, and determining threat preprocessing effect by combining real-time monitoring data obtained by the data monitoring module;
where when the threat preprocessing effect meets a first preset condition, marking related threat event processing state as a first state, and performing a preset duration and level monitoring on threat events in the first state through the data monitoring module;
when monitoring results meet a second preset condition, releasing the first state of the threat events, and releasing isolation of related systems, and simultaneously outputting corresponding threat processing strategies and threat processing methods to the security management submodule;
when threat events corresponding to the third threat information is preprocessed by the self-defined strategies and methods, and threat preprocessing results with meeting the first preset condition and the second preset condition are obtained, updating the self-defined strategies and methods to the historical threat coping strategy-method database, and simultaneously updating corresponding threat events to the historical threat database, and building a mapping relationship between threat events and corresponding self-defined strategies and methods.

Preferably, the log generation module includes:
an abnormal data log submodule, configured for generating an abnormal data log by combining time stamps corresponding to all abnormal data obtained by identification;
where the abnormal data includes abnormal login information, abnormal access records, abnormal traffic and abnormal system events;
a threat analysis log submodule, configured for obtaining process data in a process of secondary identification of abnormal information by the threat analysis module, and outputting to obtain a threat identification log by combining time sequence features corresponding to identification results in the threat identification information;
a risk processing log submodule, configured for obtaining matching process data of strategies and methods and process data of performing security management on abnormal events, and outputting to obtain a risk processing log;
a standardization submodule, configured for performing standardization processing on the abnormal data log, the threat identification log and the risk processing log, and respectively outputting to obtain a first log, a second log and a third log by combining corresponding time features;
an abnormal activity analysis submodule, configured for monitoring the first log, the second log and the third log in real time by using preset log monitoring tools, identifying abnormal activities in the log data, performing positioning according to pre-marked positioning beacons marked in the log data, obtaining occurrence time, types and activity frequencies of abnormal activities, and outputting to obtain log abnormal data;
a daily management submodule, configured for analyzing the log abnormal data by combining preset log management tools, processing the log abnormal data by combining preset management measures, simultaneously setting corresponding storage strategies and access authority levels by combining corresponding access requirements of the log data, and generating log daily management data;
a security management submodule, configured for encrypting sensitive log data based on corresponding security requirements of the log data and combining a preset encryption method, and simultaneously generating log security management data according to accessed records and modified records of the log data;
a threat management log generation submodule, configured for generating a threat management log based on the first log, the second log and the third log, the log abnormal data, log daily management data and log security management data.

Preferably, the secondary identification submodule includes:
a feature data set generating unit, configured for performing feature extraction on the abnormal information and generating a feature data set;
where, the feature data set includes node log data, network traffic data, device behavior data and user behavior data;
a data set to be tested generating unit, configured for selecting feature data in the feature data set by using preset selection instructions to obtain a data set to be tested;
a height determination unit, configured for performing sample division on the data set to be tested and determining outlier heights of divided data;

$$hi = {log}_{2} {η}_{i} ;$$

where hi represents an outlier height of i-th divided data; ηᵢ represents an outlier data amount of i-th divided data;
performing feature clustering on each subdata in each of the divided data to obtain a clustering center and a clustering radius of each of clustering results, and performing circumferential closed area division on the clustering results to construct a clustering sequence

$$JX = \{ Y {1}_{j 2} , j 2 = 1 , 2 , 3 , … , [ \frac{2 \times Jb}{{Δ}_{Jz , Jt}} ] + 1 \}$$

corresponding to the clustering results, where Y1ⱼ₂ represents data density of subdata existing in j2-th circumferential closed area; Jb represents a corresponding clustering radius; A_{Jz, Jt} represents a corresponding unit division length; [ ] represents a downward rounding symbol;
calculating an anomaly index S of corresponding divided data according to the clustering sequence and the outlier heights;

$$S = Y {1}_{1} + \frac{{\sum }_{j 2 = 1}^{[ \frac{2 \times Jb}{{Δ}_{Jz , Jt}} ]} Y {1}_{j 2} - Y {1}_{1}}{[ \frac{2 \times Jb}{{Δ}_{Jz , Jt}} ]} \times {γ}_{i} \times {2}^{- \frac{\sqrt[2]{{( {E}_{h ( xj )} )}^{2} + {D}_{h ( xj )}}}{c ( n )}} ;$$

where, γᵢ represents a data ratio of i-th divided data to all data in the data set to be tested; Eₕ₍ₓⱼ₎ represents an average value of discrete heights of all divided data; Dₕ₍ₓⱼ₎ represents population variance of the discrete heights of all divided data; c(n) represents a distance average value between a clustering center of i-th divided data and clustering centers of other divided data; Y1₁ represents data density of subdata existing in a first circumferential closed area;
an anomaly analysis unit, configured for comparing and analyzing anomaly index of each divided data with a preset threshold, and determining threat types corresponding to each divided data by combining mapping rules; and
a threat level determining unit, configured for determining a threat level corresponding to each of the threat types based on attack number, attack types, involved system types and corresponding number of threat events corresponding to the threat types.

The network security operation workbench provided by the disclosure may realize real-time monitoring of network events through the data monitoring module, and identify abnormal data therein, and then the abnormal information may be performed secondary identification through the threat analysis module, so as to obtain the threat types and levels corresponding to each abnormal event, which not only improves the recognition accuracy of the platform for increasingly diversified threat events, but also improves the flexibility of the platform to deal with diversified threat events. Then, the identified threat events are performed safety processing through the risk processing module, which improves the security of the platform. At the same time, the log generation module may record the process of identifying and analyzing abnormal events and the process of safe processing, which provides data support and convenience for the subsequent identification and processing of threat events.

### BRIEF DESCRIPTION OF THE DRAWINGS

In order to explain the technical scheme of the disclosure or the related art more clearly, the drawings needed to be used in the description of the embodiments or the related art will be briefly introduced below. Obviously, the drawings in the following description are some embodiments of the disclosure, and other drawings may be obtained according to these drawings without creative efforts for ordinary skilled in the field.

FIG. 1 is a schematic architectural diagram of a network security operation workbench provided by an embodiment of the disclosure; and

FIG. 2 is a clustering result diagram provided by an embodiment of the disclosure.

### DETAILED DESCRIPTION OF THE EMBODIMENTS

In order to make the purpose, technical scheme and advantages of the disclosure more clear, the technical scheme in the disclosure will be described clearly and completely with reference to the attached drawings in the disclosure. Obviously, the described embodiments are a part of the embodiments of the disclosure, but not all of embodiments. Based on the embodiments in the disclosure, all other embodiments obtained by ordinary skilled in the field without creative efforts belong to the scope of protection of the disclosure.

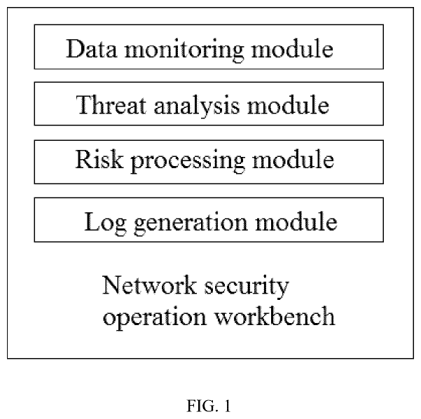

A network security operation workbench of the disclosure will be described below with reference to FIG. 1.

FIG. 1 is a schematic architectural diagram of the network security operation workbench provided by an embodiment of the disclosure.

As shown in FIG. 1, a network security operation workbench provided by an embodiment of the disclosure includes:
a data monitoring module, configured for performing security monitoring on network events in systems, identifying abnormal data and outputting to obtain abnormal information;
a threat analysis module, configured for performing secondary identification on the abnormal information by using preset identification algorithms, obtaining threat types and levels corresponding to abnormal events in the abnormal information, and generating threat identification information;
a risk processing module, configured for analyzing the threat identification information, matching to obtain corresponding coping strategies and methods, and performing security management operations on the abnormal events based on the coping strategies and methods; and
a log generation module, configured for recording an identification and analysis process and a security management operation process of each of abnormal events in the systems and generating a threat management log.

In this embodiment, the network events are: behaviors generated by all nodes in the network, including various network devices, servers, containers and sensors, which usually exist in some form such as logs and messages.

In this embodiment, the abnormal data is: the data corresponding to each network event is detected by the data monitoring module to obtain data deviating from normal data, such as abnormal ip access, abnormal traffic, abnormal period access, etc.

In this embodiment, the abnormal information is: information obtained according to abnormal data output, which provides convenience for subsequent data analysis.

In this embodiment, the preset identification algorithms are: an algorithm for identifying abnormal events in abnormal information and obtaining corresponding threat types and levels, which are preset, for example, a large number of network logs and network data are analyzed by machine learning algorithms such as decision trees and random forests, and abnormal modules and threat events are identified.

In this embodiment, the abnormal events are: abnormal events in network behavior, including non-threatening events and threatening events.

In this embodiment, the threat types and levels are: the threat types corresponding to each abnormal event and the threat levels under the corresponding types. Generally, the more threat types of abnormal events, the more severe the security situation faced by the system, and the higher the probability of being attacked or even breached. The higher the threat level of the threat event, the greater the negative impact of the threat on the system.

In this embodiment, the threat identification information is: information including information of threat types and levels corresponding to abnormal events in the abnormal information, so as to provide data support for subsequent security management operations.

In this embodiment, the coping strategies and methods are: coping strategies and processing methods for each of abnormal events to reduce or eliminate the possible negative impact of threatening events on the system.

In this embodiment, the security management operation is: the operation of processing the corresponding abnormal events according to the matched coping strategies and methods, such as isolation, deletion, labeling, etc.

In this embodiment, the threat management log is: a log recorded according to the identification and analysis process and security management operation process of each abnormal event, which provides data support for the subsequent identification or processing of similar or identical abnormal events.

The implementation principle and beneficial effects of this embodiment: the data monitoring module may realize real-time monitoring of network events and identify abnormal data therein, and then the threat analysis module may perform secondary identification on abnormal information to obtain the threat types and levels corresponding to each abnormal event, which not only improves the recognition accuracy of the platform for increasingly diversified threat events, but also improves the flexibility of the platform to deal with diversified threat events. Then, the identified threat events are processed safely through the risk processing module, which improves the security of the platform. At the same time, the log generation module may record the process of identifying and analyzing abnormal events and the process of safe processing, which provides data support and convenience for the subsequent identification and processing of threat events.

The network security operation workbench are provided by the disclosure, where the data monitoring module includes:
a data obtaining submodule, configured for obtaining log data of all the network events in the systems and preprocessing the log data to obtain initial data; and
a data identification submodule, configured for identifying and analyzing abnormal data in the initial data and outputting to obtain the abnormal information.

In this embodiment, the log data is: data recorded by the system for each of network events, such as network access, access ip, access path, etc.

In this embodiment, the preprocessing is: an operation for improving the validity of data and facilitating subsequent data processing, such as cleaning invalid data, removing or supplementing missing values in data, etc.

In this embodiment, the initial data is: data obtained after preprocessing the log data.

The implementation principle and beneficial effects of this embodiment: the data obtaining submodule may not only accurately obtain the completed or ongoing log data in the system, but also preprocess the log data, which not only eliminates the influence of invalid data or missing data on abnormal analysis results, but also improves the data quality and effectiveness of the log data, thereby improving the accuracy of subsequent abnormal data identification and analysis results.

The network security operation workbench is provided by the disclosure, where the threat analysis module includes:
a first feature extraction submodule, configured for performing feature extraction on the abnormal information to obtain abnormal data features; and
an algorithm matching submodule, configured for selecting and obtaining corresponding preset identification algorithms in an algorithm database based on the abnormal data features.

In this embodiment, the feature extraction is: a process of extracting data features such as abnormal values, abnormal frequencies, abnormal associations, abnormal behaviors and the like from abnormal information through the first feature extraction submodule.

In this embodiment, the abnormal data features are: data features obtained by feature extraction of abnormal information through the first feature extraction submodule, such as abnormal ip login, abnormal traffic increment, etc.

In this embodiment, the algorithm database is: a database including a large number of threat identification algorithms for abnormal events.

In this embodiment, the preset identification algorithms are: algorithms screened from the algorithm database and used to analyze the threat types and levels of abnormal events, which are preset, such as support vector machines (SVM), decision trees, neural networks and other algorithms.

The implementation principle and beneficial effects of this embodiment: the the first feature extraction submodule may extract data features from abnormal information, and output the abnormal data features, which not only improves the extraction efficiency and accuracy of data features, but also improves the diversity of data features. At the same time, according to the preset identification algorithm screened in the algorithm database, it can help the system to automatically monitor and identify abnormal data points, improve the accuracy and efficiency of algorithm identification, and help the system find potential security threats or abnormal events in time.

The network security operation workbench is provided by the disclosure, where the threat analysis module further includes:
a secondary identification submodule, configured for performing secondary identification on abnormal information by using the preset identification algorithms to obtain threat type information and corresponding level information of each of the abnormal events;
an information generation module, configured for counting the threat type information and corresponding level information of all the abnormal events to generate threat identification information.

In this embodiment, the secondary identification is: the process of identifying the threat types and corresponding levels of abnormal events in abnormal information by the system through preset identification algorithms, which is different from the process and method of identifying abnormal data for the first time.

In this embodiment, the threat type information is: the type corresponding to each threat event, such as software that maliciously attacks the system such as Trojan horses and viruses; Phishing links that obtain personal information through fake websites or fake emails.

In this embodiment, the level information is: the corresponding level of each threat event under the corresponding threat type. The higher the level, the greater the harm and negative impact on the system, such as low-level threats such as interference with system operation; intermediate threats such as system service interruption or non-critical data leakage; advanced threats such as serious damage to the system or serious data leakage.

In this embodiment, the threat identification information is: information including information of threat types and levels corresponding to all abnormal events in the abnormal information.

The implementation principle and beneficial effects of this embodiment: the secondary identification submodule may use the preset identification algorithms selected from the algorithm database to perform secondary identification on abnormal information, which greatly improves the accuracy of the determination results of the threat types and corresponding threat levels of the system to abnormal events in abnormal information, and continuously improves the identification ability of the system to gradually diversified and secretive threat events, thus providing accurate data support for subsequent threat protection operations.

The network security operation workbench is provided by the disclosure, where the risk processing module includes:
a second feature extraction submodule, configured for performing feature extraction on features from the threat identification information to obtain threat data features;
a strategy-method matching submodule, configured for matching in a preset strategy and method database based on the threat data features to obtain corresponding threat processing strategies and threat processing methods;
a security management submodule, configured for performing security management operations on corresponding abnormal events in the systems based on the threat processing strategies and the threat processing methods.

In this embodiment, the threat data features are: data features extracted from threat identification information, including type features and level features of threat events.

In this embodiment, the preset strategy and method database is: a database storing a large number of strategies and methods for eliminating threat events.

In this embodiment, the threat processing strategy: includes prevention strategy, monitoring strategy, response strategy and optimization strategy to continuously improve the efficiency of security protection operation.

In this embodiment, the threat processing method: includes methods such as isolating the infected system, restoring damaged data, analyzing the threat source, and restoring system vulnerabilities, so as to reduce or eliminate the negative impact of threat events on the system and provide reference for the prevention of future network security threat events.

The implementation principle and beneficial effects of this embodiment: the second feature extraction submodule may accurately extract the data features in the threat identification information to obtain the threat data features with high reliability and high information content, and then the strategy-method matching submodule is used to select and obtain the threat processing strategy and threat processing method matching with the threat types and levels of abnormal events in the database. Furthermore, through the security management submodule, all abnormal events in the system may be managed safely, so as to reduce the negative impact of threatened events on the system, improve the security of the system, and provide convenience for the prevention of the same or similar threatened events in the future.

The network security operation workbench is provided by the disclosure, where the strategy-method matching submodule includes:
a factor obtaining unit, configured for converting the threat data features into a threat matching factor with a preset format;
an information matching unit, configured for selecting historical threat information with a matching degree greater than a first preset degree in a historical threat database based on the threat matching factor, and outputting to obtain first threat information;
historical threat information with a matching degree less than the first preset degree but greater than a second preset degree from the historical threat database is simultaneously selected, and is output to obtain second threat information;
where when a matching degree in the historical threat database based on the threat matching factor is less than the second preset degree, corresponding threat data features are converted into an online identification format, and are transmitted to a cloud database for identification and analysis, and are output to obtain third threat information based on identification results and manual determining results;
a historical strategy-method matching unit, configured for obtaining corresponding historical threat processing strategies and historical threat processing methods in a historical threat coping strategy-method database based on the first threat information and the second threat information;
a strategy design unit, configured for isolating threat events and related systems by combining level information corresponding to threat when input threat information is the third threat information, performing threat coping strategy design through system self-matching instructions and manual operation instructions, and outputting self-defined strategies and methods; and
a threat preprocessing unit, configured for preprocessing corresponding threat events based on the historical threat processing strategies, the historical threat processing methods and the self-defined strategies and methods, and determining threat preprocessing effect by combining real-time monitoring data obtained by the data monitoring module;
where when the threat preprocessing effect meets a first preset condition, related threat event processing state is marked as a first state, and a preset duration and level monitoring is performed on threat events in the first state through the data monitoring module;
when monitoring results meet a second preset condition, the first state of the threat events is released, and isolation of related systems is released, and corresponding threat processing strategies and threat processing methods are simultaneously output to the security management submodule;
when threat events corresponding to the third threat information is preprocessed by the self-defined strategies and methods, and threat preprocessing results with meeting the first preset condition and the second preset condition are obtained, the self-defined strategies and methods are updated to the historical threat coping strategy-method database, and corresponding threat events are simultaneously updated to the historical threat database, and a mapping relationship between threat events and corresponding self-defined strategies and methods is built.

In this embodiment, the preset format is: the data format adapted to the information matching unit, which is preset, and the speed and efficiency of subsequent data matching may be improved by format conversion of data features.

In this embodiment, the threat matching factor is: a matching factor used to select the corresponding historical threat information from the historical threat database.

In this embodiment, the historical threat database is: a database that stores relevant data of past threat events, which is used to provide reference for later threat event identification and processing.

In this embodiment, the first preset degree is: a matching degree threshold of the first threat information obtained by screening in the historical threat database.

In this embodiment, the first threat information is: the historical threat information screened in the historical threat database and having a matching degree with the threat matching factor greater than a first preset degree, which is highly similar threat information, for example, if the first preset degree is 98%, the historical threat information with a matching degree greater than 98% with the threat matching factor is the first threat information.

In this embodiment, the second preset degree is: a matching degree threshold for screening the second threat information in the historical threat database.

In this embodiment, the second threat information is: the historical threat information screened from the historical threat database and the matching degree with the threat matching factor being greater than the second preset degree and less than the first preset degree, which is reference similar threat information. For example, the first preset degree is 98% and the second preset degree is 90%, the historical threat information with a matching degree of less than 98% and more than 90% with the threat matching factor is the second threat information, which is used as a reference for the first threat information.

In this embodiment, the online identification format is: a data format for online identification.

In this embodiment, the cloud database is: a database that stores more richer information about the threat types and levels than the local historical threat database, and when the local historical threat database is difficult to identify the current threat, it is transported to the cloud database for identification.

In this embodiment, the manual determining results are: the threat determining results made by relevant security technicians, which are used in combination with the identification results of the cloud database.

In this embodiment, the third threat information is: threat identification results obtained by synthesizing the identification result of the cloud database and the manual determining results.

In this embodiment, the historical threat coping strategy-method database is: a database storing historical threat processing strategies and historical threat processing methods for responding to corresponding historical threat events.

In this embodiment, the historical threat processing strategies are: the processing strategies for the system to respond to each of historical threat events;

In this embodiment, the historical threat processing methods are: the processing methods for the system to respond to each of historical threat events.

In this embodiment, the system self-matching instructions are: the system self-matching strategy design instructions, which are usually obtained by the model output obtained through big data training.

In this embodiment, the manual operation instructions are: operation instructions for manual strategy design.

In the embodiment, the self-defined strategies and methods are: strategies and methods obtained by combining the system self-matching instructions and the manual operation instructions to design the threat coping strategy, and the corresponding threat events are generally new threat types, and there is no corresponding historical coping strategies and methods to refer to.

In this embodiment, the preprocessing is: an operation of preprocessing threat events to preliminarily determine the effect of strategies and methods.

In this embodiment, the threat preprocessing effect is: the effect of threat preprocessing obtained through determining.

In this embodiment, the first preset condition is: the determining condition for determining whether the threat event processing state is the first state, which is preset.

In this embodiment, the first state is: a state that the system is still in a threatened state, but the negative impact on the related systems involved has been alleviated, but not completely eliminated.

In this embodiment, the preset duration and level is: the monitoring duration and the corresponding monitoring level for continuously monitoring the threat event in the first state.

In this embodiment, the second preset condition is: a threshold condition used to release that first state of the threat event and the isolation operation of the corresponding system, which is preset, and the second preset condition in the disclosure is that the threat event has been completely eliminated and the negative impact of the involved system has been completely eliminated.

The implementation principle and beneficial effects of this embodiment: the threat data features are converted into threat matching factors in a preset format, and then the corresponding historical threat information is quickly and accurately matched by the information matching unit, and when the adapted first threat information and second threat information cannot be screened in the historical threat database, the threat data features may be identified and analyzed in combination with the cloud database, thus greatly improving the identification accuracy of the system for threat events and the flexibility of the system. At the same time, the threat processing unit may process the threat events with the help of historical threat processing strategies, historical threat processing methods and self-defined strategies and methods, which improves the operability and flexibility of the system to response to threat events.

The network security operation workbench is provided by the disclosure, where the log generation module includes:
an abnormal data log submodule, configured for generating an abnormal data log by combining time stamps corresponding to all abnormal data obtained by identification;
where the abnormal data includes abnormal login information, abnormal access records, abnormal traffic and abnormal system events;
a threat analysis log submodule, configured for obtaining process data in a process of secondary identification of abnormal information by the threat analysis module, and outputting to obtain a threat identification log by combining time sequence features corresponding to identification results in the threat identification information;
a risk processing log submodule, configured for obtaining matching process data of strategies and methods and process data of performing security management on abnormal events, and outputting to obtain a risk processing log;
a standardization submodule, configured for performing standardization processing on the abnormal data log, the threat identification log and the risk processing log, and respectively outputting to obtain a first log, a second log and a third log by combining corresponding time features;
an abnormal activity analysis submodule, configured for monitoring the first log, the second log and the third log in real time by using preset log monitoring tools, identifying abnormal activities in the log data, performing positioning according to pre-marked positioning beacons marked in the log data, obtaining occurrence time, types and activity frequencies of abnormal activities, and outputting to obtain log abnormal data;
a daily management submodule, configured for analyzing the log abnormal data by combining preset log management tools, processing the log abnormal data by combining preset management measures, simultaneously setting corresponding storage strategies and access authority levels by combining corresponding access requirements of the log data, and generating log daily management data;
a security management submodule, configured for encrypting sensitive log data based on corresponding security requirements of the log data and combining a preset encryption method, and simultaneously generating log security management data according to accessed records and modified records of the log data;
a threat management log generation submodule, configured for generating a threat management log based on the first log, the second log and the third log, the log abnormal data, log daily management data and log security management data.

In this embodiment, the time stamps are: time identifications such as the occurrence time, disappearance time and duration of each abnormal data, which are used to record the occurrence time of each abnormal event.

In this embodiment, the abnormal data log is: a log containing abnormal data and corresponding time stamps.

In this embodiment, the threat identification log is: a log containing the process data of secondary identification of abnormal information and the corresponding time sequence features, for example, a log that A-kind low-level threat event occurs at 1 moment, ends at 3 moments, and lasts for 2 moments.

In this embodiment, the risk processing log is: a log containing the process data of performing security management operations on various abnormal events and the corresponding time sequence features, for example, a log file that uses I-type strategies and methods to process the A-kind low-level threats that occurs at 1 moment and eliminate at 3 moments.

In this embodiment, the time feature are: the time nodes corresponding to the log data in each abnormal data log, threat identification log and risk processing log after standardization processing.

In this embodiment, the first log is: an abnormal data log after standardization processing.

In this embodiment, the second log is: a threat identification log after standardization processing.

In this embodiment, the third log is: a risk processing log after standardization processing.

In this embodiment, the preset log monitoring tools are: tools for monitoring abnormal activities in log data, which are preset, for example, tools such as Datadog and Loggly.

In this embodiment, the abnormal activities are: abnormal data in log data, such as code abnormality, multiple login failures, unauthorized access, intrusion attempts and other activities.

In this embodiment, the positioning beacons are: a method for quickly locating abnormal data, finding and locating the location and activities of threats in time, and performing monitoring.

In this embodiment, the log abnormal data is: data including information such as the location, occurrence time, type and activity frequency of each abnormal activity.

In this embodiment, the preset log management tools are: tools for daily management of logs, which are preset, for example, tools such as Graylog and Sumo logic.

In this embodiment, the preset management measures are: measures and methods for processing log abnormal data, which are preset, such as monitoring and early warning, interference filtering, aggregation analysis and other methods.

In this embodiment, the access requirements are: the accessed requirements of each log data.

In this embodiment, the storage strategies are: strategies for storing the log data, such as the storage time of the log data, the adopted storage medium, etc.

In this embodiment, the access authority levels are: the authority level for accessing each log data. For example, if the access authority of the log data of the core system is level-8, users higher than or equal to level-8 may access the log data of the core system to ensure the security of confidential data.

In this embodiment, log daily management data is: data including abnormal log processing, log access and other log daily management operations;

In this embodiment, the security requirements are: security requirements such as confidentiality, integrity and availability of log data to ensure that data is not tampered with and leaked.

In this embodiment, the preset encryption method is: the encryption method used to encrypt the log data to prevent data leakage and tampering, which is preset, such as symmetric encryption, hash encryption, key encryption, etc.

In this embodiment, the log security management data is: data including the data related to log security, such as encryption method, accessed record, modified record, etc. corresponding to the log data.

In this embodiment, the threat management log is: a log that is comprehensively generated according to the first log, the second log and the third log, as well as log abnormal data, log daily management data and log security management data.

The implementation principle and beneficial effects of this embodiment: the abnormal data is recorded through the abnormal data log submodule, and the threat identification and analysis process of each abnormal event contained in each abnormal information are recorded through the threat analysis log submodule, and at the same time, the processing process of security management operation of each abnormal data is recorded through the risk processing log submodule, thus realizing the whole process data recording of abnormal data identification, threat event identification and threat event processing. At the same time, the log data is monitored and analyzed by combining the log abnormal data, log daily management data and log security management data, which improves the security and reliability of the log data.

The network security operation workbench is provided y the disclosure, where the secondary identification submodule includes:
a feature data set generating unit, configured for performing feature extraction on the abnormal information and generating a feature data set;
where, the feature data set includes node log data, network traffic data, device behavior data and user behavior data;
a data set to be tested generating unit, configured for selecting feature data in the feature data set by using preset selection instructions to obtain a data set to be tested;
a height determination unit, configured for performing sample division on the data set to be tested and determining outlier heights of divided data.

$$hi = {log}_{2} {η}_{i} ;$$

where hi represents an outlier height of i-th divided data; ηᵢ represents an outlier data amount of i-th divided data;
feature clustering is performed on each subdata in each of the divided data to obtain a clustering center and a clustering radius of each of clustering results, and circumferential closed area division is performed on the clustering results to construct a clustering sequence

$$JX = \{ Y {1}_{j 2} , j 2 = 1 , 2 , 3 , … , [ \frac{2 \times Jb}{{Δ}_{Jz , Jt}} ] + 1 \}$$

corresponding to the clustering results, where Y1ⱼ₂ represents data density of subdata existing in j2-th circumferential closed area; Jb represents a corresponding clustering radius; Δ_{Jz, Jt} represents a corresponding unit division length; [ ] represents a downward rounding symbol;

In this embodiment, for example, the divided data A1 has feature 1 and feature 2, and the results obtained after clustering according to feature 1 include subdata 01, subdata 02 and subdata 09, and the results obtained after clustering according to feature 2 include subdata 03, subdata 04 and subdata 05.

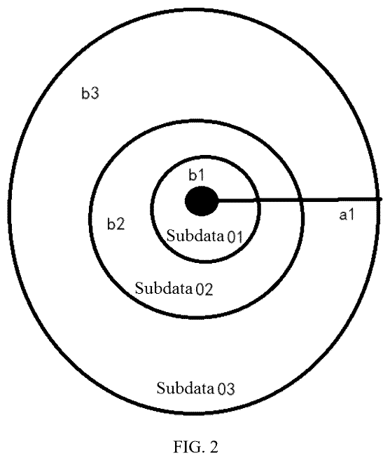

In this embodiment, for the clustering result of feature 1, as shown in FIG. 2, for example, the distribution of subdata 01 as the clustering center, subdata 02 and subdata 03 is shown in the figure, and the clustering radius refers to al, and the circumferential enclosed areas are b1, b2 and b3.
an anomaly index S of corresponding divided data is calculated according to the clustering sequence and the outlier heights;

$$S = Y {1}_{1} + \frac{{\sum }_{j 2 = 1}^{[ \frac{2 \times Jb}{{Δ}_{Jz , Jt}} ]} Y {1}_{j 2} - Y {1}_{1}}{[ \frac{2 \times Jb}{{Δ}_{Jz , Jt}} ]} \times {γ}_{i} \times {2}^{- \frac{\sqrt[2]{{( {E}_{h ( xj )} )}^{2} + {D}_{h ( xj )}}}{c ( n )}} ;$$

where, γᵢ represents a data ratio of i-th divided data to all data in the data set to be tested; Eₕ₍ₓⱼ₎ represents an average value of discrete heights of all divided data; Dₕ₍ₓⱼ₎ represents population variance of the discrete heights of all divided data; c(n) represents a distance average value between a clustering center of i-th divided data and clustering centers of other divided data; Y1₁ represents data density of subdata existing in a first circumferential closed area.
an anomaly analysis unit, configured for comparing and analyzing anomaly index of each divided data with a preset threshold, and determining threat types corresponding to each divided data by combining mapping rules; and
a threat level determining unit, configured for determining a threat level corresponding to each of the threat types based on attack number, attack types, involved system types and corresponding number of threat events corresponding to the threat types.

In this embodiment, the feature data set is: a data set composed of features obtained by feature extraction of abnormal information.

In this embodiment, the node log data is: data includes alarm, operation log, audit log and other data generated by each node.

In this embodiment, the network traffic data is: data of the incoming and outgoing network traffic of all network events.

In this embodiment, the device behavior data is: behavior data including the known connection and new connection, location and network interaction of the device.

In this embodiment, the user behavior data is: the user behavior data in the network environment, such as frequent visits by the same ip user, failed login of accounts in different places for many times, etc.

In this embodiment, the preset selection instructions are: the instructions for selecting data features in the feature data set, which are preset.

In this embodiment, the data set to be tested is: a data set composed of multiple selected feature data.

In this embodiment, the feature clustering is: a method for clustering analysis of data features, which is helpful to find potential structures and patterns in abnormal feature data, so as to find potential threats in time.

In this embodiment, the preset threshold is: a threshold for comparative analysis with the abnormal indexes of each divided data, which is preset.

In this embodiment, the mapping rules are: the data features under each divided data and the mapping relationship between the anomaly index and the threat type.

The implementation principle and beneficial effects of this embodiment: the feature data in abnormal information may be extracted by the feature data set generation unit, and the feature data set containing diversified data may be output. Then, the selected data set to be tested is analyzed by the preset outlier algorithm. Based on the obtained analysis results and the mapping rules, the threat types and threat levels of each divided data in the data set to be tested are obtained, which greatly improves the accuracy and efficiency of threat identification.

Finally, it should be explained that the above embodiments are only used to illustrate the technical scheme of the disclosure, but not to limit it. Although the disclosure has been described in detail with reference to the foregoing embodiments, those skilled in the art should understand that it is still possible to modify the technical scheme described in the foregoing embodiments, or to replace some technical features with equivalents. However, these modifications or substitutions may not make the essence of the corresponding technical solutions deviate from the spirit and scope of the technical solutions of various embodiments of the disclosure.

What is claimed is:

1. A network security operation workbench, comprising:
a data monitoring module, configured for performing security monitoring on network events in systems, identifying abnormal data and outputting to obtain abnormal information;
a threat analysis module, configured for performing secondary identification on the abnormal information by using preset identification algorithms, obtaining threat types and levels corresponding to abnormal events in the abnormal information, and generating threat identification information;
a risk processing module, configured for analyzing the threat identification information, matching to obtain corresponding coping strategies and methods, and performing security management operations on the abnormal events based on the coping strategies and methods;
a log generation module, configured for recording an identification and analysis process and a security management operation process of each of abnormal events in the systems and generating a threat management log.

2. The network security operation workbench according to claim 1, wherein the data monitoring module comprises:
a data obtaining submodule, configured for obtaining log data of all the network events in the systems and preprocessing the log data to obtain initial data; and
a data identification submodule, configured for identifying and analyzing abnormal data in the initial data and outputting to obtain the abnormal information.

3. The network security operation workbench according to claim 1, wherein the threat analysis module comprises:
a first feature extraction submodule, configured for performing feature extraction on the abnormal information to obtain abnormal data features; and
an algorithm matching submodule, configured for selecting and obtaining corresponding preset identification algorithms in an algorithm database based on the abnormal data features.

4. The network security operation workbench according to claim 3, wherein the threat analysis module further comprises:
a secondary identification submodule, configured for performing secondary identification on abnormal information by using the preset identification algorithms to obtain threat type information and corresponding level information of each of the abnormal events;
an information generation module, configured for counting the threat type information and corresponding level information of all the abnormal events to generate threat identification information.

5. The network security operation workbench according to claim 1, wherein the risk processing module comprises:
a second feature extraction submodule, configured for performing feature extraction on features from the threat identification information to obtain threat data features;
a strategy-method matching submodule, configured for matching in a preset strategy and method database based on the threat data features to obtain corresponding threat processing strategies and threat processing methods;
a security management submodule, configured for performing security management operations on corresponding abnormal events in the systems based on the threat processing strategies and the threat processing methods.

6. The network security operation workbench according to claim 5, wherein the strategy-method matching submodule comprises:
a factor obtaining unit, configured for converting the threat data features into a threat matching factor with a preset format;
an information matching unit, configured for selecting historical threat information with a matching degree greater than a first preset degree in a historical threat database based on the threat matching factor, and outputting to obtain first threat information;
simultaneously selecting historical threat information with a matching degree less than the first preset degree but greater than a second preset degree from the historical threat database, and outputting to obtain second threat information;
wherein when a matching degree in the historical threat database based on the threat matching factor is less than the second preset degree, converting corresponding threat data features into an online identification format, and transmitting to a cloud database for identification and analysis, and outputting to obtain third threat information based on identification results and manual determining results;
a historical strategy-method matching unit, configured for obtaining corresponding historical threat processing strategies and historical threat processing methods in a historical threat coping strategy-method database based on the first threat information and the second threat information;
a strategy design unit, configured for isolating threat events and related systems by combining level information corresponding to threat when input threat information is the third threat information, performing threat coping strategy design through system self-matching instructions and manual operation instructions, and outputting self-defined strategies and methods; and
a threat preprocessing unit, configured for preprocessing corresponding threat events based on the historical threat processing strategies, the historical threat processing methods and the self-defined strategies and methods, and determining threat preprocessing effect by combining real-time monitoring data obtained by the data monitoring module;
wherein when the threat preprocessing effect meets a first preset condition, marking related threat event processing state as a first state, and performing a preset duration and level monitoring on threat events in the first state through the data monitoring module;
when monitoring results meet a second preset condition, releasing the first state of the threat events, and releasing isolation of related systems, and simultaneously outputting corresponding threat processing strategies and threat processing methods to the security management submodule;
when threat events corresponding to the third threat information is preprocessed by the self-defined strategies and methods, and threat preprocessing results with meeting the first preset condition and the second preset condition are obtained, updating the self-defined strategies and methods to the historical threat coping strategy-method database, and simultaneously updating corresponding threat events to the historical threat database, and building a mapping relationship between threat events and corresponding self-defined strategies and methods.

7. The network security operation workbench according to claim 1, wherein the log generation module comprises:
an abnormal data log submodule, configured for generating an abnormal data log by combining time stamps corresponding to all abnormal data obtained by identification;
wherein the abnormal data comprises abnormal login information, abnormal access records, abnormal traffic and abnormal system events;
a threat analysis log submodule, configured for obtaining process data in a process of secondary identification of abnormal information by the threat analysis module, and outputting to obtain a threat identification log by combining time sequence features corresponding to identification results in the threat identification information;
a risk processing log submodule, configured for obtaining matching process data of strategies and methods and process data of performing security management on abnormal events, and outputting to obtain a risk processing log;
a standardization submodule, configured for performing standardization processing on the abnormal data log, the threat identification log and the risk processing log, and respectively outputting to obtain a first log, a second log and a third log by combining corresponding time features;
an abnormal activity analysis submodule, configured for monitoring the first log, the second log and the third log in real time by using preset log monitoring tools, identifying abnormal activities in the log data, performing positioning according to pre-marked positioning beacons marked in the log data, obtaining occurrence time, types and activity frequencies of abnormal activities, and outputting to obtain log abnormal data;
a daily management submodule, configured for analyzing the log abnormal data by combining preset log management tools, processing the log abnormal data by combining preset management measures, simultaneously setting corresponding storage strategies and access authority levels by combining corresponding access requirements of the log data, and generating log daily management data;
a security management submodule, configured for encrypting sensitive log data based on corresponding security requirements of the log data and combining a preset encryption method, and simultaneously generating log security management data according to accessed records and modified records of the log data;
a threat management log generation submodule, configured for generating a threat management log based on the first log, the second log and the third log, the log abnormal data, log daily management data and log security management data.

8. The network security operation workbench according to claim 4, wherein the secondary identification submodule comprises:
a feature data set generating unit, configured for performing feature extraction on the abnormal information and generating a feature data set;
wherein, the feature data set comprises node log data, network traffic data, device behavior data and user behavior data;
a data set to be tested generating unit, configured for selecting feature data in the feature data set by using preset selection instructions to obtain a data set to be tested;
a height determination unit, configured for performing sample division on the data set to be tested and determining outlier heights of divided data;
wherein
$$hi = {log}_{2} {η}_{i} ;$$
wherein hi represents an outlier height of i-th divided data; ηᵢ represents an outlier data amount of i-th divided data;
performing feature clustering on each subdata in each of the divided data to obtain a clustering center and a clustering radius of each of clustering results, and performing circumferential closed area division on the clustering results to construct a clustering sequence
$$JX = \{ Y {1}_{j 2} , j 2 = 1 , 2 , 3 , … , [ \frac{2 \times Jb}{{Δ}_{Jz , Jt}} ] + 1 \}$$
corresponding to the clustering results, wherein Y1ⱼ₂ represents data density of subdata existing in j2-th circumferential closed area; Jb represents a corresponding clustering radius; Δ_{Jz, Jt} represents a corresponding unit division length; [ ] represents a downward rounding symbol;
calculating an anomaly index S of corresponding divided data according to the clustering sequence and the outlier heights;
$$S = Y {1}_{1} + \frac{{\sum }_{j 2 = 1}^{[ \frac{2 \times Jb}{{Δ}_{Jz , Jt}} ]} Y {1}_{j 2} - Y {1}_{1}}{[ \frac{2 \times Jb}{{Δ}_{Jz , Jt}} ]} \times {γ}_{i} \times {2}^{- \frac{\sqrt[2]{{( {E}_{h ( xj )} )}^{2} + {D}_{h ( xj )}}}{c ( n )}} ;$$
wherein, γᵢ represents a data ratio of i-th divided data to all data in the data set to be tested; Eₕ₍ₓⱼ₎ represents an average value of discrete heights of all divided data; Dₕ₍ₓⱼ₎ represents population variance of the discrete heights of all divided data; c(n) represents a distance average value between a clustering center of i-th divided data and clustering centers of other divided data; Y1₁ represents data density of subdata existing in a first circumferential closed area;
an anomaly analysis unit, configured for comparing and analyzing anomaly index of each divided data with a preset threshold, and determining threat types corresponding to each divided data by combining mapping rules; and
a threat level determining unit, configured for determining a threat level corresponding to each of the threat types based on attack number, attack types, involved system types and corresponding number of threat events corresponding to the threat types.
